(19) United States
(12) Patent Application Publication
(10) Pub. No.: US 2009/0031546 A1
(43) Pub. Date: Feb. 5, 2009

(54) Residential door hinge pin remover

(76) Inventor: Brian Lee Horne, Galloway, OH (US)

Correspondence Address: Brian Horne, 5681 Erika Ct, Galloway, OH, 43119, US

(21) Appl. No.: 12/219,879

(22) Filed: Jul. 29, 2008

Related U.S. Application Data
(60) Provisional application No. 60/962,585, filed on Jul. 30, 2007.

(51) Int. Cl. B25B 27/02

(52) U.S. Cl. 29/275

(57) ABSTRACT

A tool for removing residential door hinge pins. The small hand tool has a drive rod extending out of the top center of handle. Embodied in a cylindrical cone shaped handle with magnetic horns extending out evenly horizontally up from the bottom of tool. The moon-shaped protrusion secure door pins to the tool, so that the door pins don't drop on to the new tile or a brand new hard wood floors causing damage while removing door hinge pins. When the residential door hinge pin remover is used the drive rod is placed up under door hinge pin hole (and with the magnetic horns facing away from all wood) and forced upward by any hammer. Once the neck of the pin is exposed the moon-shaped protrusion are placed under the neck of the pins and forced the rest of the way out for easy and safe removing.

### CROSS REFERENCE TO RELATED APPLICATION

This application claims the benefit of a provisional application #60/962,585 filed on Jul. 30, 2007.

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

This tool is for movers, carpet installers, tile installers, maintenance men, or home owners that do home projects around the house involving removing door hinge pins.

This invention relates to a tool for the removal of door hinge pins. More particularly, for the removal of door hinge pins, this hinge pin remover includes a steel drive rod that extends up from the top of a handle, on which close to the bottom of the handle is a moon-shaped horizontal protrusion which fits snuggly around a hinge pin just below the head of the pin and can be magnetized so as to “hold” the pin to the hinge pin remover without allowing it to fall to the floor.

Typically, hinge pins in residential doors are removed by the use of a flat head screwdriver, vice grips, sixteen penny nails, etc. However, the use of these items causes damage to the doors, door frames, hinge pins, and the hinges themselves. Furthermore, due to the lack of a “perfect” fit onto the hinge pin, a large amount of time is used to remove the hinge pins, especially if the hinge pins are painted or rusted onto the hinges.

The hinge pin remove as set forth in this invention quickly, efficiently, and precisely removes a hinge pin without causing damage to any of the surrounding pieces.

### SUMMARY OF THE INVENTION

The tool of the present invention includes a drive rod which is about two to four inches long which extends from the top center position of a handle. The drive rod is positioned under the door hinge pin hole at the bottom of the hinge and the drive rod is forced upward, dislodging the hinge pin. Close to the bottom of the handle is positioned a moon-shaped protrusion that extends horizontally which can fit snuggly around the shaft of the hinge below the head of the hinge and can be magnetized so as to “hold” the pin to the hinge pin remover without allowing it to fall to the floor.

### DESCRIPTION OF THE DRAWINGS

Illustrated in the accompanying drawings are at least one of the best mode embodiments of the present invention. The following is a brief description of the drawings in which like parts bear like reference numerals and in which:

FIG. 1 is illustrating a right side view of residential door hinge pin remover including its elements;

FIG. 2 is illustrating the top view of residential door hinge pin remover;

### DESCRIPTION OF THE PREFERRED EMBODIMENT

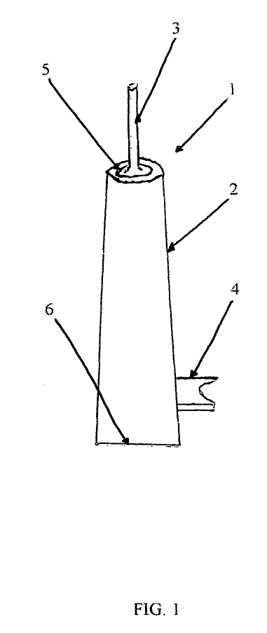

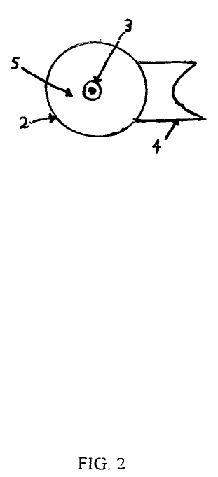

Referring now more particularly to the drawings, a door hinge pin remover embodying the principles of the present invention is shown generally in FIGS. 1 and 2. The door hinge pin remover 1 is shown as having a handle 2, a drive rod 3, and a moon-shaped protrusion 4. The handle 2 can be made out of any sturdy and durable material such as aluminum, hardened plastic, steel, wood, stone, etc.; however steel or aluminum are the preferred materials. The drive rod 1 can be made out of any sturdy and durable material such as aluminum, hardened plastic, steel, wood, stone, etc.; however steel or aluminum are the preferred materials. The moon-shaped protrusion 4 can be made out of any material, but preferably a magnetized material.

The handle 2 can be any shape; however for the ease of grasping the tool 1, a cylindrical cone-shaped stylization is preferred since this shape does not come into contact with the surrounding hardware such as a hinge, door, frame, etc. From the top center plane 5 of the handle 2, a drive rod 3 is permanently attached so as to extend upward. The drive rod 3 can be of any length, but typically two to four inches is preferred. The moon-shaped protrusion 4 is permanently affixed to the handle 2 so as to extend horizontally out from the handle 2 close to the bottom of the handle 2. The moon-shaped protrusion 4 is fabricated so that the concave portion fits snuggly around a standard door hinge pin and can be magnetized to prevent the hinge pin from inadvertently falling from the tool 1 to the floor. The bottom 6 of the handle 2 can be flat.

While certain representative embodiments and details have been shown for the purpose of illustrating the invention, it will be apparent to those skilled in this art that various changes and modifications may be made therein without departing from the scope of the invention.

What is claimed is:

1. A tool for removing door hinge pins, comprising:
a cylindrical cone-shaped handle;
a drive rod that extends upward from said handle;
a moon-shaped protrusion that extends horizontally from said handle.

2. The tool defined in claim 1 wherein said drive rod extends upward from a top center plane of said handle.

3. The tool defined in claim 1 wherein said handle has a flat bottom.

4. The tool defined in claim 1 wherein the moon-shaped protrusion is magnetized.
